(19) United States
(12) Patent Application Publication
(10) Pub. No.: US 2006/0199547 A1
(43) Pub. Date: Sep. 7, 2006

(54) Power compensation in a mobile station

(75) Inventor: Young-Joong Song, Gyeonggi-Do (KR)

Correspondence Address: JONATHAN Y. KANG, ESQ.;LEE, HONG, DEGERMAN, KANG & SCHMADEKA, P.C., 14th Floor, 801 S. Figueroa Street, Los Angeles, CA, 90017-5554, US

(73) Assignee: LG Electronics Inc.

(21) Appl. No.: 11/361,563

(22) Filed: Feb. 24, 2006

(30) Foreign Application Priority Data
Feb. 26, 2005 (KR) 10-2005-0016287

(51) Int. Cl. H04B 17/00

(52) U.S. Cl. 455/67.11

(57) ABSTRACT

A method for compensating power of a mobile communications terminal is provided, the method performing additional power compensation according to channels with respect to shifting power losses of a duplexer. The method performs basic compensation with no consideration to the channels with respect to power losses according to temperature, implements a table capable of compensating losses due to shifting characteristics of the duplexer which occur at a specific channel and temperature, and further performs power loss compensation by the duplexer in addition to the basic temperature compensation with respect to a signal pertaining to corresponding temperature and channel region in order that transmission power can be provided as desired target power even in extremely high or low temperature and sensitivity can be maintained by compensating reception power.

### CROSS-REFERENCE TO RELATED APPLICATIONS

Pursuant to 35 U.S.C. § 119(a), this application claims the benefit of earlier filing date and right of priority to Korean Application No. 2005-0016287, filed on Feb. 26, 2005, the contents of which are hereby incorporated by reference herein in their entirety.

### FIELD OF THE INVENTION

The present invention relates generally to a mobile station and, more particularly, to power compensation in a mobile station.

### BACKGROUND OF THE INVENTION

A mobile station amplifies transmission and/or reception power at a constant amplification degree. However, the desired target power may still not be outputted, due to physical characteristics of transmission/reception devices in the mobile station. The physical characteristics of these devices may be nonlinear, and may be affected by operational temperature and frequency (e.g., channel). Therefore, output power of the mobile station must be compensated.

In one compensation method, a mobile station outputs power at a level near a target output level, and a sensor senses changes in temperature. A previously set compensation value from a compensation table is obtained, and automatic gain control is applied to transmission power based on the corresponding compensation value. Compensation of transmission/reception power of a mobile station using a previously manufactured communication modem is performed using a temperature compensation table provided from a modem manufacturer.

FIG. 1 is a block diagram illustrating construction of a transmission unit of an exemplary mobile station, and a temperature compensation table.

Referring to FIG. 1, when power is applied to a modem, such as a modem manufactured by Qualcomm Incorporated® used in a CDMA (code-division-multiple-access) method, for example, power is compensated with respect to a corresponding temperature region of a temperature compensation table, e.g., NV_CDMA_TX_LIM_VS_TEMP_I, provided from the corresponding manufacturer. However, a use channel according to a change in temperature is not considered in such power compensation. Instead, the power compensation is routinely performed with respect to the temperature. In addition, with respect to FIG. 1, the power compensation with respect to temperature depends on the temperature compensation table written on the basis of temperature measurement by a sensor 80, and the magnitude of power obtained by a power detector 90 that detects power outputted from the power amplifier 40.

A duplexer 30 for separating transmission/reception bands is connected to the power amplifier 40 in a transmission/reception unit of the mobile station. The duplexer 30 also suffers power losses according to operating temperature and channels, and requires power compensation. The duplexer 30 comprises precise band pass filters for separating transmission from reception. To reduce the size of the duplexer, a SAW duplexer uses surface-acoustic wave (SAW) resonators. In a SAW duplexer, a pass band is shifted according to a change in temperature. Thus, a power loss rate changes according to temperature and channels.

FIG. 2 is a graph illustrating a transmission band shift based on a temperature of the mobile station. FIG. 3 is a graph illustrating a reception band shift based on a temperature of the mobile station. As such, FIGS. 2 and 3 illustrate power characteristic curves (e.g., S parameter) of a filter of a SAW duplexer, in which a pass band is shifted according to a change in temperature. FIG. 2 is a transmission power characteristic curve of the duplexer, and FIG. 3 is a reception power characteristic curve of the duplexer.

Referring to FIGS. 2 and 3, the SAW duplexer is shifted to the right at a low temperature and shifted to the left at a high temperature. Accordingly, in case of the low temperature, severe power losses occur at lower channels of the pass band of the duplexer, and in case of the high temperature, severe power losses occur at upper channels of the pass band of the duplexer.

In order to compensate power losses based on temperature and channels of the duplexer, the power detector 90 is coupled between the duplexer 30 and a switch 20 to compensate power by detecting power outputted from the duplexer 30. However, the coupling of the power detector to the duplexer and the switch causes an impedance change of the switch 20, thereby causing difficulties in power detection. Furthermore, in case of the reception, high losses occurring at specific temperature and channels according to shifting characteristics of the duplexer cause reception sensitivity to deteriorate.

Thus, in the conventional power compensation method, since output power of the power amplifier is detected and then power compensation is performed on the basis of the detected output power, power losses according to the channels occur because of the shifting characteristics of the duplexer, according to the change in temperature, and such power losses are not compensated. Therefore, actual output power of the mobile station is different from the target power. Furthermore, received signals also suffer losses according to the channels caused by shifting of the duplexer, according to the change in temperature. If such losses are not compensated, reception sensitivity is deteriorated.

### SUMMARY OF THE INVENTION

Accordingly, the present invention is directed to power compensation in a mobile station that substantially obviates one or more problems due to limitations and disadvantages of the related art.

An object of the present invention is to provide power compensation in a mobile station with respect to power losses due to change in operational temperature.

Another object of the present invention is to provide power compensation in a mobile station with respect to power losses due to shifting characteristics of a duplexer, generated at a specific channel and temperature.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

In one aspect of the present invention, a method for controlling power in a mobile station is provided. The method includes determining a first power loss associated with an operating temperature of the mobile station, adjusting the power level of the mobile station to compensate for the determined first power loss, determining a second power loss associated with an operating temperature of the mobile station with respect to a specific operating channel and adjusting a power level of the mobile station to compensate for the determined second power loss.

Preferably, the specific operating channel of the mobile station is an upper channel or a lower channel. Preferably, the first and second power losses include a transmission power loss and/or a reception power loss.

It is contemplated that adjusting the power level of the mobile station to compensate for the determined second power loss includes compensating for a power loss due to shifting of a pass band of a duplexer according to a change in the operating temperature with respect to the specific operating channel. Preferably, adjusting the power level of the mobile station to compensate for the determined second power loss includes determining a power compensation value from a power compensation table. It is contemplated that the power compensation value is obtained by experiment based on measured temperature levels and shifting power losses of the duplexer.

In another aspect of the present invention, a method for controlling power in a mobile station is provided. The method includes selecting a temperature level by measuring an operating temperature of the mobile station, performing a first power loss compensation by obtaining a power loss compensation value corresponding to the selected temperature level from a temperature compensation table, selecting a specific channel of a frequency pass band of a duplexer, obtaining a power loss compensation value associated with the specific channel and the selected temperature level and performing a second power loss compensation with respect to the specific channel by applying automatic gain control (AGC) to the obtained power loss compensation value.

Preferably the power loss compensation compensates for a transmission power loss and/or a reception power loss. It is contemplated that the mobile station uses the specific channel to communicate a voice signal, a data signal, and/or a video signal.

Preferably, the selected channel is an upper or a lower channel of the frequency pass band of the duplexer. It is contemplated that the upper channel suffers increasingly greater power losses as the operating temperature of the mobile station increases and the lower channel suffers increasingly greater power losses as the operating temperature of the mobile station decreases.

Preferably, performing the second power loss compensation includes selecting the operating channel of the mobile station where power losses occur due to shifting characteristics of a power characteristic curve of the duplexer according to the change in the operating temperature of the mobile station. It is contemplated that performing the second power loss compensation further includes power compensation according to the change in the operating temperature of the mobile station.

In another aspect of the present invention, a method for performing power loss compensation in a mobile station is provided. The method includes selecting specific channels where power losses occur due to of pass band shifting characteristics of a duplexer according to a change in temperature from channels corresponding to a predetermined temperature region, constructing a power loss compensation table comprising power loss compensation values corresponding to the specific channels, obtaining a power loss compensation value from a basic temperature compensation table by measuring the operating temperature of the mobile station and obtaining a power loss compensation value from the power loss compensation table, wherein the measured operating temperature corresponds to a specific region and each specific channel corresponds to a specific channel region.

Preferably, the specific channels suffer greater power losses according to an increase in temperature for upper channels and greater power losses according to a decrease in temperature for lower channels. It is contemplated that the power loss compensation is performed for reception power and/or transmission power.

In another aspect of the present invention, a mobile station adapted to perform power loss compensation is provided. The mobile station includes a sensor adapted to measure an operating temperature of a transmitting end of the mobile station and to generate a sensor value corresponding to the measured temperature, a storage unit adapted to store a first power loss compensation value based on the sensor value and a second power loss compensation value corresponding to frequency pass band channels of a duplexer and the temperature measured by the sensor and a controller adapted to control a gain of a power amplifier to perform a first power compensation according to the sensor value and a second power compensation according to both the sensor value and the frequency pass band channel of the duplexer.

It is contemplated that the storage unit is adapted to store the first power loss compensation value in a temperature compensation table, wherein the temperature compensation table stores a plurality power loss compensation values generated by dividing a measurable range of the sensor value by a specific interval, the first power compensation values corresponding to the temperature levels. Preferably, the storage unit is adapted to store the second power loss compensation values corresponding to the frequency pass band channels of the duplexer according to temperature levels in a power compensation table.

It is contemplated that the controller is adapted to determine the temperature level corresponding to a sensor value and read the first power compensation value corresponding to the temperature level from the storage unit in order to control the gain of the power amplifier to perform the first power compensation. It is further contemplated that the controller is adapted to determine the temperature level corresponding to the sensor value, retrieve a specific channel currently occupied by the duplexer, and read the second power compensation value corresponding to both the determined temperature level and the specific channel in order to control the gain of the power amplifier to perform the second power compensation.

The foregoing and other objects, features, aspects and advantages of the present invention will become more apparent from the following detailed description of the present invention when taken in conjunction with the accompanying drawings. It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiments of the invention and together with the description serve to explain the principles of the invention.

FIG. 1 is a block diagram illustrating construction of a transmission unit of an exemplary mobile station, and a temperature compensation table.

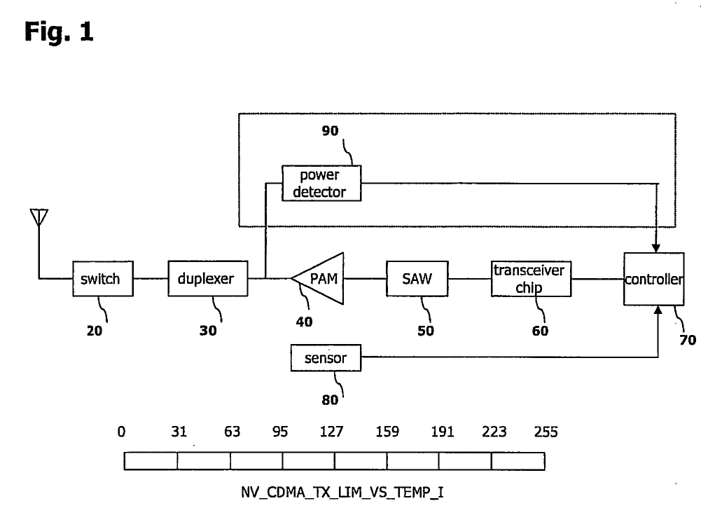

FIG. 2 is a graph illustrating a transmission band shift based on a temperature of the mobile station.

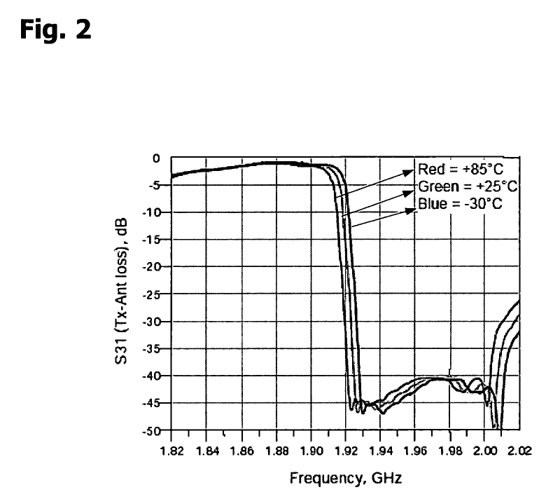

FIG. 3 is a graph illustrating a reception band shift based on a temperature of the mobile station.

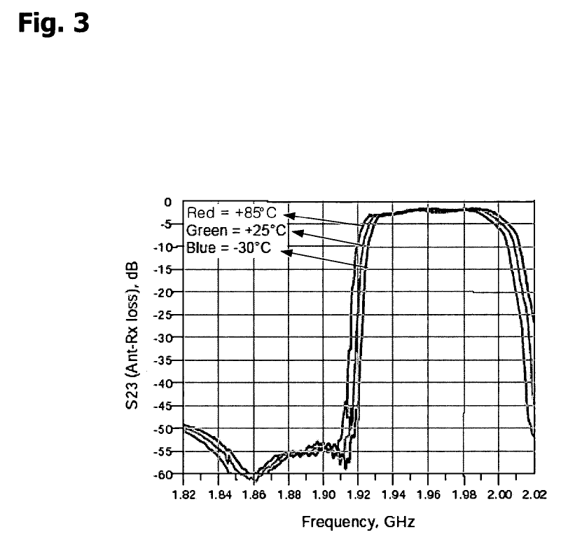

FIGS. 4A-4C are conceptual diagrams illustrating power compensation with respect to temperature and channel, according to an embodiment of the present invention.

FIG. 5 is a power compensation table organized with respect to temperature and channel, according to an embodiment of the present invention.

FIG. 6 is a flow diagram illustrating a power compensation method in a mobile station, according to an embodiment of the present invention.

FIG. 7 is a schematic block diagram illustrating a mobile station adapted to perform power compensation according to channel based on a change in temperature, according to an embodiment of the present invention.

### DETAILED DESCRIPTION OF THE PREFERRED EMBODIMENTS

Reference will now be made in detail to the preferred embodiments of the present invention, examples of which are illustrated in the accompanying drawings. Wherever possible, the same reference numbers will be used throughout the drawings to refer to the same or like parts.

There are various types of mobile stations, including mobile phones, handsets, PDAs (personal digital assistants), and computers, as well as any other devices with wireless communication capabilities. A mobile station may also be referred to as a mobile terminal, a mobile communications terminal, or a terminal. Power compensation in a mobile station is described below.

Transmission/reception power losses at a specific channel may result from a power characteristic curve of a duplexer being shifted according to a change in temperature. Therefore, power losses caused by pass band shifting characteristics of the duplexer may be compensated at the specific channel. Furthermore, basic temperature compensation with respect to power losses caused by a change in temperature of the mobile station may be performed.

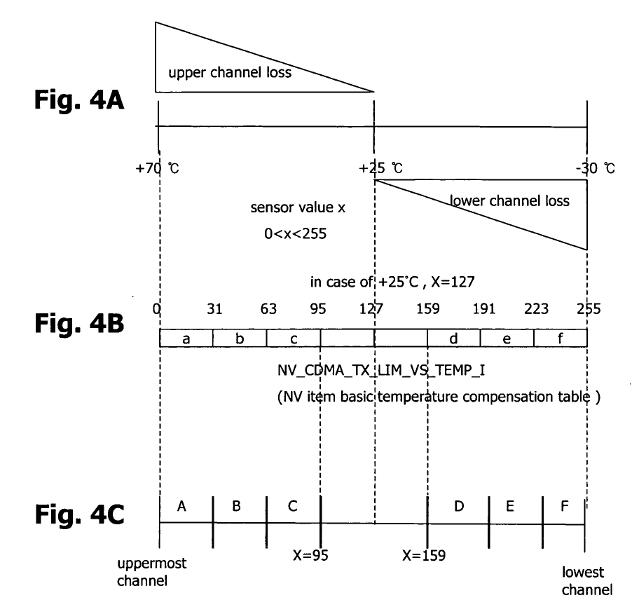

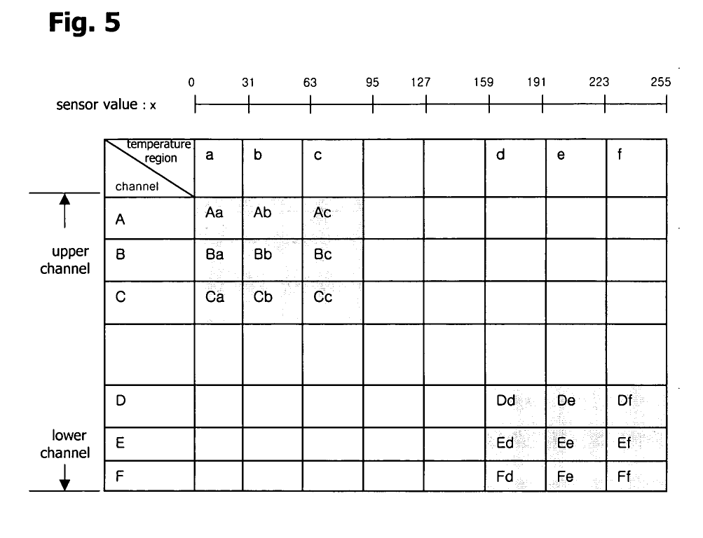

FIGS. 4A-4C and 5 illustrate use of a power compensation table to compensate power losses according to temperature and channel. FIGS. 4A-4C are conceptual diagrams illustrating power compensation with respect to temperature and channel, according to an embodiment of the present invention. As such, FIGS. 4A-4C illustrate a method for using a power compensation table according to channels to compensate losses in transmission/reception power which occur due to shifting characteristics of the power characteristic curve with respect to the temperature and channels.

FIG. 4A is a conceptual diagram illustrating power losses of a duplexer according to a change in temperature, in which the higher temperature is at or near room temperature (e.g., 25° C.). In such case, upper channels of the duplexer suffer greater power losses at higher temperatures, and the lower channels of the duplexer suffer greater power losses at lower temperatures.

FIG. 4B is a conceptual diagram illustrating a temperature compensation table based on a sensor value (e.g., x) measured in the sensor of the mobile station. The measured sensor value (x) corresponds to a certain region, and has specific values, respectively, from a temperature level of 0° C. to 255° C. As illustrated in FIG. 4B, the lower the measured temperature is (−30° C.), the higher temperature level (e.g., sensor) value (x=225) that is obtained. In addition, the higher the measured temperature is (e.g., +70° C.), the lower temperature level (e.g., sensor) value (x=0) that is obtained. On the basis of the obtained sensor value (x), it is determined which region of the basic temperature compensation table the sensor value (x) corresponds to and a preset power loss compensation value of the corresponding region is obtained, whereby basic temperature compensation may be performed.

Furthermore, the temperature compensation table divides temperature regions in which shifting of the duplexer occurs according to sections, and uses the divided temperature regions to determine whether to perform additional compensation with respect to shifting power losses of the duplexer. That is, the temperature level at which the shifting of the duplexer occurs is below 95° C. in case of the low temperature and there are a, b and c temperature level regions which are separated from each other according to the degree, for example. In case of the high temperature, the shifting of the duplexer occurs when the temperature level is above 159° C., and there are d, e and f temperature level regions that are separated from each other according to the degree, for example. Such temperature level regions may be determined by experiment, for example, and the shifting power losses of the duplexer may be considered in the temperature level regions.

FIG. 4C is a conceptual diagram illustrating a channel table requiring power compensation with respect to the shifting power losses of the duplexer which occur according to the change in temperature. As illustrated in FIG. 4C, specific channels where power losses occur due to the shifting toward the low temperature are C, B and A, while shifting power losses occur in D, E and F channels toward the high temperature. With respect to the temperature level of FIG. 4B, a channel corresponding to one region of the a, b and c regions whose temperature level inputted from the sensor is below 95° C. and suffering shifting power losses is A, B or C channel, and a channel corresponding to one region of the d, e and f regions whose temperature level is above 159° C. and suffering shifting power losses is D, E or F channel, for example.

FIG. 5 is a power compensation table organized with respect to temperature and channel, according to an embodiment of the present invention. As such, FIG. 5 illustrates a power compensation table with respect to shifting power losses of the duplexer according to temperature and channels, in which each illustrated power compensation value is an average value, which may be obtained by experiment, for example.

Referring to FIG. 5, each of the power compensation values are related to the upper channels (e.g., A, B and C channels) where power losses occur because of a shifting phenomenon of the duplexer according to a change to low temperature (e.g., ‘c’ to ‘a’ regions in FIG. 4B) and each of power compensation values are related to the lower channels (e.g., D, E and F channels) where shifting power losses occur according to a change to high temperature (‘d’ to ‘f’ regions in FIG. 4B). That is, power loss compensation in consideration of the temperature and channels is performed with respect to the upper channels (e.g., A, B and C channels) where the shifting power losses occur due to low temperature (temperature level is below 95° C.), and is performed with respect to the lower channels (e.g., D, E and F channels) where the shifting power losses occur due to high temperature (temperature level is above 159° C.).

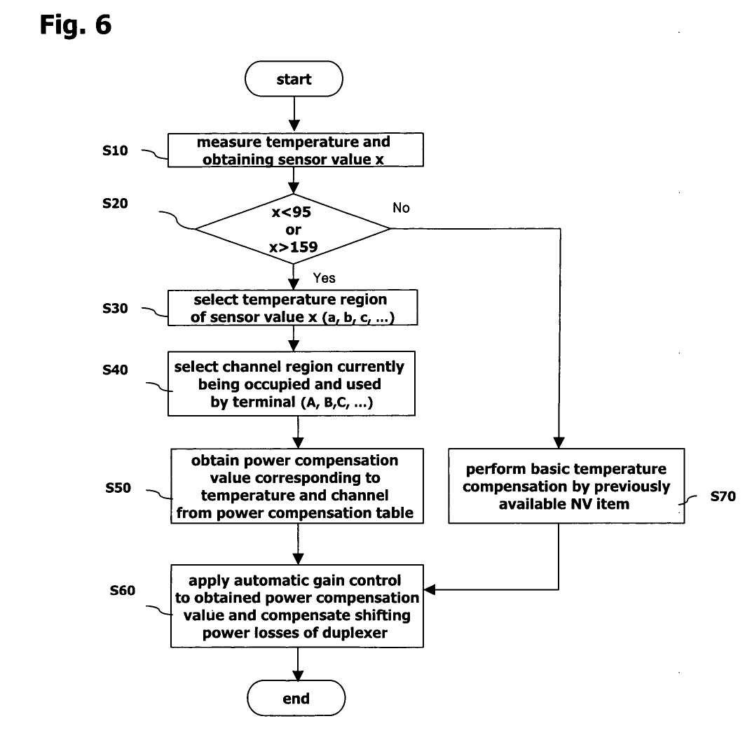

FIG. 6 is a flow diagram illustrating a power compensation method in a mobile station, according to an embodiment of the present invention.

Referring to FIG. 6, the sensor provided on the mobile station measures temperature of a transmitting end of the mobile station and obtains a corresponding sensor value (e.g., x=50) (S10). The sensor value (x=50) is used as a specification for performing temperature compensation with respect to basic power losses on the basis of a basic temperature compensation table of FIG. 4B. A determination is then made as to whether the sensor value (x=50) is below 95° C. or above 195° C. (S20). The step (S20) determines whether the power characteristic curve of the duplexer is shifted to the left or to the right due to a change in temperature. If the sensor value (x=50) is below 95° C. or above 159° C., a temperature region (e.g., b region) to which the measured sensor value (x=50) corresponds is selected (S30). Then, in the temperature region (b region) selected in the step (S30), a specific channel (e.g., A channel) which is currently occupied and used by the mobile station in order to receive/transmit voice, data or video signals is selected from the upper channels (e.g., A, B and C) affected by shifting power losses of the duplexer (S40).

A shifting power loss compensation value (e.g., Ab) corresponding to the temperature region (b region) and the channel (A channel) is then selected and obtained from a power compensation table (e.g., the table of FIG. 5) in steps (S30 and S40). An amplification degree of transmission/reception power is adjusted by applying automatic gain control to the obtained power compensation value (Ab), so that the shifting power losses of the duplexer are additionally compensated (S60). Furthermore, basic temperature compensation according to a change in temperature may be performed with respect to temperature regions (temperature level 95° C. to 159° C.) and channels where shifting power losses do not occur (S70).

A software program may implement an algorithm such as that shown in the flow diagram of FIG. 6. In addition, compensation according to temperature and channels by shifting of the duplexer may be achieved applying measurements, such as above-described graphs and simulations. Furthermore, since the additional compensation may be performed in a state where the basic temperature compensation has been performed, compensation values of the compensation table may be set accordingly.

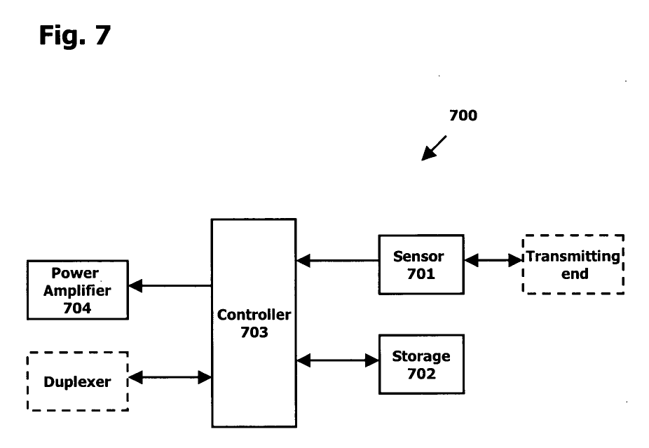

FIG. 7 is a block diagram illustrating a mobile station 700 adapted to perform power compensation of a channel based on a change in temperature, according to an embodiment of the present invention.

Referring to FIG. 7, the mobile station 700 includes a sensor 701 to measure a temperature of a transmitting end and to obtain a sensor value (e.g., temperature level value) corresponding to the measured temperature, a storage unit 702 to store a first power compensation value according to the sensor value measured by the sensor 701 and a second power compensation value obtained with respect to frequency pass band channels of a duplexer according to a particular temperature level corresponding to the sensor value measured by the sensor 701, a controller 703 to control a gain of the duplexer to respectively perform a first power compensation using the sensor value measured by the sensor 701 and a second power compensation using both the sensor value and the frequency pass band channel of the duplexer, and a power amplifier 704 to perform the first and second power compensations under the control of the controller 703.

The storage unit 703 stores the first power compensation value in a particular temperature compensation table. That is, the particular temperature compensation table contains a plurality of temperature levels, which are formed by dividing a measurable range of the sensor value by a particular interval and the first power compensation values corresponding to the respective temperature levels. The storage unit 703 also stores the second power compensation values corresponding to the frequency pass band channels of the duplexer according to each temperature level in a power compensation table.

The controller 704 determines the temperature level corresponding to the sensor value measured by the sensor 701 as the first power compensation value, and reads the first power compensation value corresponding to the temperature level from the storage unit 703 to control the gain of the power amplifier 704 for compensating transmission/reception power corresponding to the first power compensation value. The controller 704 also determines the temperature level corresponding to the sensor value measured by the sensor as the second power compensation value, retrieves a specific channel which is currently occupied from the duplexer, and reads the second power compensation value corresponding to both the determined temperature level and the specific channel to control the gain of the power amplifier 704 for compensating transmission/reception power corresponding to the read second power compensation value.

The mobile station 700 may also include an RF unit to transmit/receive signals, keypad and display as input and output devices, a microphone to input voice, a speaker to output ring tones, and a battery to supply power

The present invention may enable transmission/reception to be performed with stable power in high-temperature and low-temperature environments, by performing power loss compensation corresponding to channels according to a change in temperature, in addition to basic temperature compensation. Accordingly, high-reliability communication services may be provided to the user even in a cold storage warehouse or a sauna, for example, by maintaining stable transmission and reception power, regardless of the operational temperature of the mobile stations or the channels used.

It will be apparent to those skilled in the art that various modifications and variations may be made in the present invention without departing from the spirit or scope of the inventions. Thus, it is intended that the present invention covers the modifications and variations of this invention provided they come within the scope of the appended claims and their equivalents.

What is claimed is:

1. A method for controlling power in a mobile station, the method comprising:
determining a first power loss associated with an operating temperature of the mobile station;
adjusting the power level of the mobile station to compensate for the determined first power loss;
determining a second power loss associated with an operating temperature of the mobile station with respect to a specific operating channel; and
adjusting a power level of the mobile station to compensate for the determined second power loss.

2. The method of claim 1, wherein the specific operating channel of the mobile station is one of an upper channel and a lower channel.

3. The method of claim 1, wherein the first and second power losses comprise at least one of a transmission power loss and a reception power loss.

4. The method of claim 1, wherein adjusting the power level of the mobile station to compensate for the determined second power loss comprises compensating for a power loss due to shifting of a pass band of a duplexer according to a change in the operating temperature with respect to the specific operating channel.

5. The method of claim 4, wherein adjusting the power level of the mobile station to compensate for the determined second power loss comprises determining a power compensation value from a power compensation table.

6. The method of claim 5, wherein the power compensation value is obtained by experiment based on measured temperature levels and shifting power losses of the duplexer.

7. A method for controlling power in a mobile station, the method comprising:
selecting a temperature level by measuring an operating temperature of the mobile station;
performing a first power loss compensation by obtaining a power loss compensation value corresponding to the selected temperature level from a temperature compensation table;
selecting a specific channel of a frequency pass band of a duplexer;
obtaining a power loss compensation value associated with the specific channel and the selected temperature level; and
performing a second power loss compensation with respect to the specific channel by applying automatic gain control (AGC) to the obtained power loss compensation value.

8. The method of claim 7, wherein the power loss compensation compensates for at least one of a transmission power loss and a reception power loss.

9. The method of claim 7, wherein the mobile station uses the specific channel to communicate at least one of a voice signal, a data signal, and a video signal.

10. The method of claim 7, wherein the selected channel is one of an upper and a lower channel of the frequency pass band of the duplexer.

11. The method of claim 10, wherein, the upper channel suffers increasingly greater power losses as the operating temperature of the mobile station increases and the lower channel suffers increasingly greater power losses as the operating temperature of the mobile station decreases.

12. The method of claim 7, wherein performing the second power loss compensation comprises selecting the operating channel of the mobile station where power losses occur due to shifting characteristics of a power characteristic curve of the duplexer according to the change in the operating temperature of the mobile station.

13. The method of claim 12, wherein performing the second power loss compensation further comprises power compensation according to the change in the operating temperature of the mobile station.

14. A method for performing power loss compensation in a mobile station, the method comprising:
selecting specific channels where power losses occur due to of pass band shifting characteristics of a duplexer according to a change in temperature from channels corresponding to a predetermined temperature region;
constructing a power loss compensation table comprising power loss compensation values corresponding to the specific channels;
obtaining a power loss compensation value from a basic temperature compensation table by measuring the operating temperature of the mobile station; and
obtaining a power loss compensation value from the power loss compensation table, wherein the measured operating temperature corresponds to a specific region and each specific channel corresponds to a specific channel region.

15. The method of claim 14, wherein the specific channels suffer greater power losses according to an increase in temperature for upper channels and greater power losses according to a decrease in temperature for lower channels.

16. The method of claim 14, wherein the power loss compensation is performed for at least one of reception power and transmission power.

17. A mobile station adapted to perform power loss compensation, the mobile station comprising:
a sensor adapted to measure an operating temperature of a transmitting end of the mobile station and to generate a sensor value corresponding to the measured temperature;
a storage unit adapted to store a first power loss compensation value based on the sensor value and a second power loss compensation value corresponding to frequency pass band channels of a duplexer and the temperature measured by the sensor; and
a controller adapted to control a gain of a power amplifier to perform a first power compensation according to the sensor value and a second power compensation according to both the sensor value and the frequency pass band channel of the duplexer.

18. The mobile station of claim 17, wherein the storage unit is adapted to store the first power loss compensation value in a temperature compensation table, wherein the temperature compensation table stores a plurality power loss compensation values generated by dividing a measurable range of the sensor value by a specific interval, the first power compensation values corresponding to the temperature levels.

19. The mobile station of claim 17, wherein the storage unit is adapted to store the second power loss compensation values corresponding to the frequency pass band channels of the duplexer according to temperature levels in a power compensation table;

20. The mobile station of claim 17, wherein the controller is adapted to determine the temperature level corresponding to a sensor value and read the first power compensation value corresponding to the temperature level from the storage unit in order to control the gain of the power amplifier to perform the first power compensation.

21. The mobile station of claim 17, wherein the controller is adapted to determine the temperature level corresponding to the sensor value, retrieve a specific channel currently occupied by the duplexer, and read the second power compensation value corresponding to both the determined temperature level and the specific channel in order to control the gain of the power amplifier to perform the second power compensation.
